(19) United States
(12) Patent Application Publication
(10) Pub. No.: US 2018/0173140 A1
(43) Pub. Date: Jun. 21, 2018

(54) HEATING ROTATING MEMBER AND HEATING APPARATUS

(71) Applicant: CANON KABUSHIKI KAISHA, Tokyo (JP)

(72) Inventors: Toru Imaizumi, Kawasaki-shi (JP); Ken Nakagawa, Yokohama-shi (JP); Takashi Narahara, Mishima-shi (JP); Takeshi Shinji, Yokohama-shi (JP); Kazuhiro Doda, Yokohama-shi (JP); Kohei Wakatsu, Kawasaki-shi (JP)

(21) Appl. No.: 15/578,858

(22) PCT Filed: Jun. 15, 2016
(86) PCT No.: PCT/JP2016/002883

§ 371 Date: Dec. 1, 2017

(30) Foreign Application Priority Data
Jun. 22, 2015 (JP) 2015-125037
Jun. 7, 2016 (JP) 2016-113423

(51) Int. Cl. G03G 15/20

(52) U.S. Cl. CPC G03G 15/2057; G03G 2215/2048; G03G 15/2064

(57) ABSTRACT

A tubular film used for a fixing apparatus, including: a heat generating layer; a first conductive layer and a second conductive layer provided respectively at one end and another end of the film in a longitudinal direction of the film so as to contact the heat generating layer, the first conductive layer and the second conductive layer both having a lower volume resistivity than the heat generating layer; and a low-resistance layer formed in an area of the heat generating layer between the first conductive layer and the second conductive layer in the longitudinal direction so as not to contact the first conductive layer and the second conductive layer, the low-resistance layer having a lower volume resistivity than the heat generating layer and extending in a circumferential direction of the heat generating layer.

### TECHNICAL FIELD

The present invention relates to a heating apparatus used, for example, for image forming apparatuses such as printers and copiers, and a heating rotating member used for the heating apparatus.

### BACKGROUND ART

As a heating apparatus used for conventional image forming apparatuses such as printers and copiers, for example, the heating apparatus described in Japanese Patent Application Laid-open No. 2013-97315 is known.

This heating apparatus has a heating rotating member, a power feeding member for feeding power to the heating rotating member, and a pressurizing member that comes into pressure contact with the heating rotating member to form a nip portion. By feeding power to the heating rotating member to generate Joule heat, the heating apparatus allows high-speed start-up and saves energy. The heating rotating member has a heat generating layer coated with an insulating layer. The heating rotating member generates heat by feeding power directly to the heat generating layer, enabling a reduction in warm-up time.

### CITATION LIST

### Patent Literature

[PTL 1]

Japanese Patent Application Laid-Open No. 2013-97315

### SUMMARY OF INVENTION

### Technical Problem

However, in the conventional heating rotating member, the insulating layer may be damaged by being rubbed by foreign matter entering the image forming apparatus or by recording materials, and the damage may even reach the heat generating layer. Moreover, for example, in connection with a jam eliminating process forcibly executed by a user, the heat generating layer may be damaged by a cutter, for example. The heat generating layer damaged in this manner may locally increase a current density around ends of the damage, leading to abnormal heat generation in the corresponding portions.

### Solution to Problem

An object of the present invention is to provide a tubular film used for a fixing apparatus, comprising:

a heat generating layer;

a first conductive layer and a second conductive layer provided respectively at one end and another end of the film in a longitudinal direction of the film so as to contact the heat generating layer, the first conductive layer and the second conductive layer both having a lower volume resistivity than the heat generating layer; and

a low-resistance layer formed in an area of the heat generating layer between the first conductive layer and the second conductive layer in the longitudinal direction so as not to contact the first conductive layer and the second conductive layer, the low-resistance layer having a lower volume resistivity than the heat generating layer and extending in a circumferential direction of the heat generating layer.

Another object of the present invention is to provide a tubular film used for a fixing apparatus, comprising:

a heat generating layer; and

a plurality of low-resistance layers formed in an area of the heat generating layer at least except for one end and another end of the film in a longitudinal direction of the film, the low-resistance layers being formed at intervals in the longitudinal direction so as not to contact one another, and the low-resistance layers have a lower volume resistivity than the heat generating layer and extend in a circumferential direction of the heat generating layer.

Another object of the present invention is to provide a fixing apparatus that fixes an image to a recording material, comprising:

a heating rotating member having a heat generating layer and a first conductive layer and a second conductive layer provided respectively at one end and another end of the heating rotating member in a longitudinal direction of the heating rotating member so as to contact the heat generating layer, the first conductive layer and the second conductive layer both having a lower volume resistivity than the heat generating layer; and

power feeding members that contact the first conductive layer and the second conductive layer, respectively,

wherein the heat generating layer generates heat by a current flowing between the power feeding members of the heat generating layer, and

the image is fixed to the recording material by heat from the heating rotating member, and

wherein the heating rotating member has a low-resistance layer formed in an area of the heat generating layer between the first conductive layer and the second conductive layer in the longitudinal direction so as not to contact the first conductive layer and the second conductive layer, the low-resistance layer having a lower volume resistivity than the heat generating layer and extending in a circumferential direction of the heat generating layer.

Another object of the present invention is to provide a fixing apparatus that fixes an image to a recording material comprising:

a heating rotating member having a heat generating layer;

power feeding members that contact one end and another end of the heating rotating member in a longitudinal direction of the heating rotating member, the heat generating layer generating heat by a current flowing between the power feeding members of the heat generating layer; and

a pressurizing member that forms a nip portion in cooperation with the heating rotating member;

wherein, in the nip portion, the recording material on which the image is formed thereon is heated while being conveyed to fix the image to the recording material, and

wherein the heating rotating member has a plurality of low-resistance layers formed in a conveying area for the recording material in the heat generating layer at intervals in the longitudinal direction so as not to contact one another, each of the low-resistance layers having a lower volume resistivity than the heat generating layer and extending in a circumferential direction of the heat generating layer.

Further features of the present invention will become apparent from the following description of exemplary embodiments with reference to the attached drawings.

### BRIEF DESCRIPTION OF DRAWINGS

FIG. 1A and FIG. 1B depict a fixing film serving as a heating rotating member according to Embodiment 1 of the present invention, FIG. 1A is a front schematic view, and FIG. 1B is an enlarged sectional schematic view taken along a longitudinal direction;

FIGS. 2A to 2C are sectional schematic diagrams of the fixing film in FIG. 1A and FIG. 1B;

FIG. 3A and FIG. 3B schematically depict a fixing apparatus that is a heating apparatus using the fixing film in FIG. 1A and FIG. 1B, FIG. 3A is a sectional view, and FIG. 3B is a perspective view;

FIG. 4A and FIG. 4B are diagrams illustrating flows of currents through the fixing film in a normal state;

FIG. 5A and FIG. 5B are diagrams illustrating flows of currents through the fixing film when cracking occurs;

FIG. 6A and FIG. 6B depict a fixing roller serving as a heating rotating member according to Embodiment 2 of the present invention;

FIGS. 7A to 7C are sectional schematic diagrams of the fixing roller in FIG. 5A and FIG. 5B;

FIG. 8A and FIG. 8B are schematic diagrams of a fixing apparatus that is a heating apparatus using the fixing roller in FIG. 6A and FIG. 6B;

FIG. 9 is a front schematic view of a fixing film serving as a heating rotating member according to Embodiment 3 of the present invention;

FIG. 10A and FIG. 10B are schematic diagrams of a fixing film serving as a heating rotating member according to Embodiment 4 of the present invention;

FIGS. 11A to 11C are sectional schematic diagrams of the fixing film in FIG. 10A and FIG. 10B;

FIGS. 12A to 12C are diagrams depicting flows of currents through the fixing film in the normal state according to Embodiment 4;

FIGS. 13A to 13C are diagrams depicting flows of currents through the fixing film when cracking occurs according to Embodiment 4;

FIG. 14A and FIG. 14B are schematic diagrams of a fixing film serving as a heating rotating member according to Embodiment 5 of the present invention;

FIGS. 15A to 15C are sectional schematic diagrams of the fixing film in FIG. 14A and FIG. 14B; and

FIG. 16 is a referential drawing illustrating flows of currents through a fixing film with no low-resistance layer when cracking occurs.

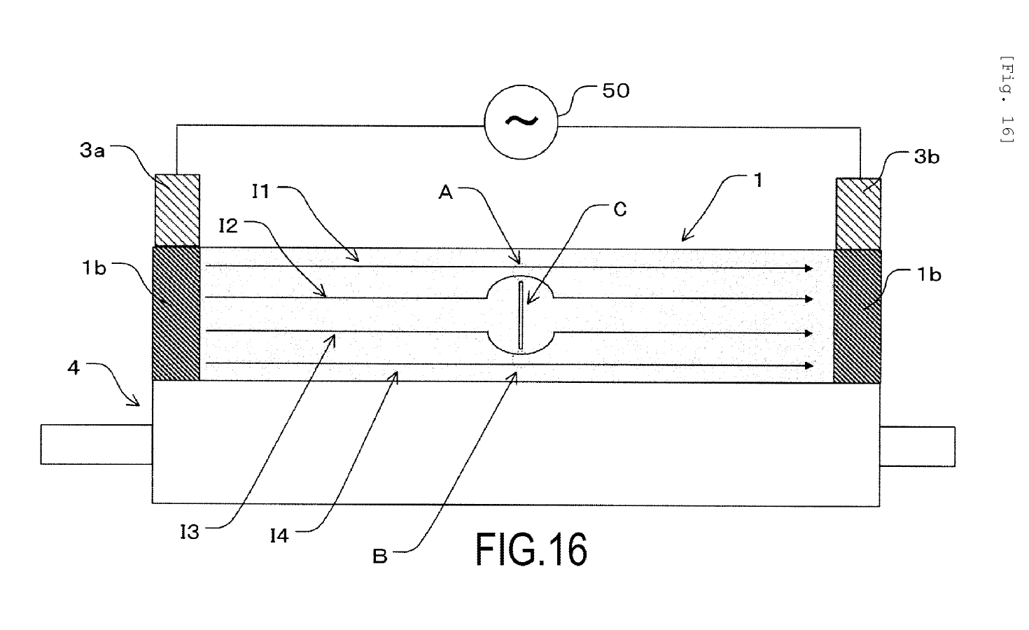

### DESCRIPTION OF EMBODIMENTS

The present invention will be described below in detail based on illustrated embodiments.

In the description below, a longitudinal direction represents a generatrix direction of a cylindrical shape of a heating rotating member surface. A circumferential direction represents a rotating direction of the heating rotating member surface corresponding to a circumferential direction of the cylindrical shape. A thickness direction represents a radial direction of the cylindrical shape of the heating rotating member surface.

### Embodiment 1

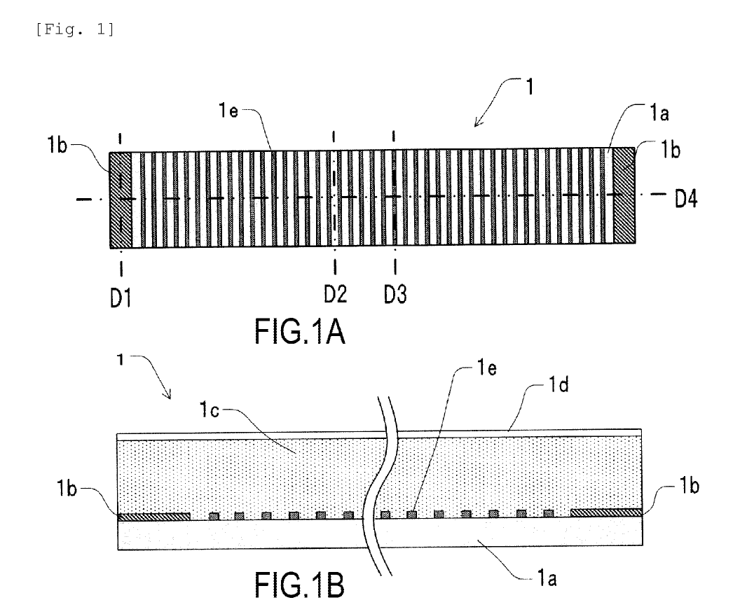

FIGS. 1A to 5B depict a fixing film serving as a heating rotating member and a fixing apparatus according to Embodiment 1 of the present invention.

First, a configuration of the fixing film serving as the heating rotating member will be described. Then, a fixing apparatus using the fixing film will be described.

(Description of the Fixing Film)

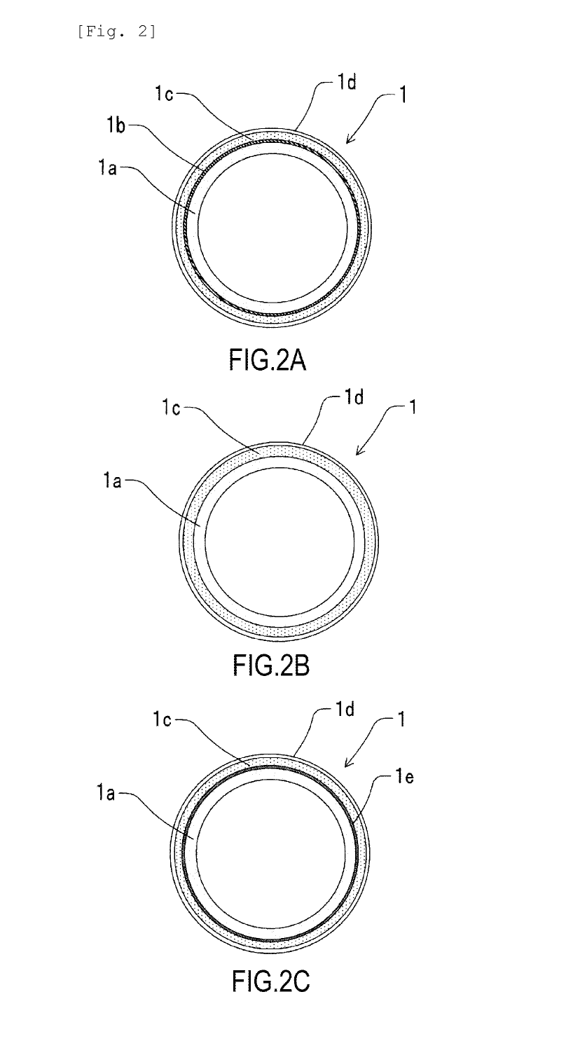

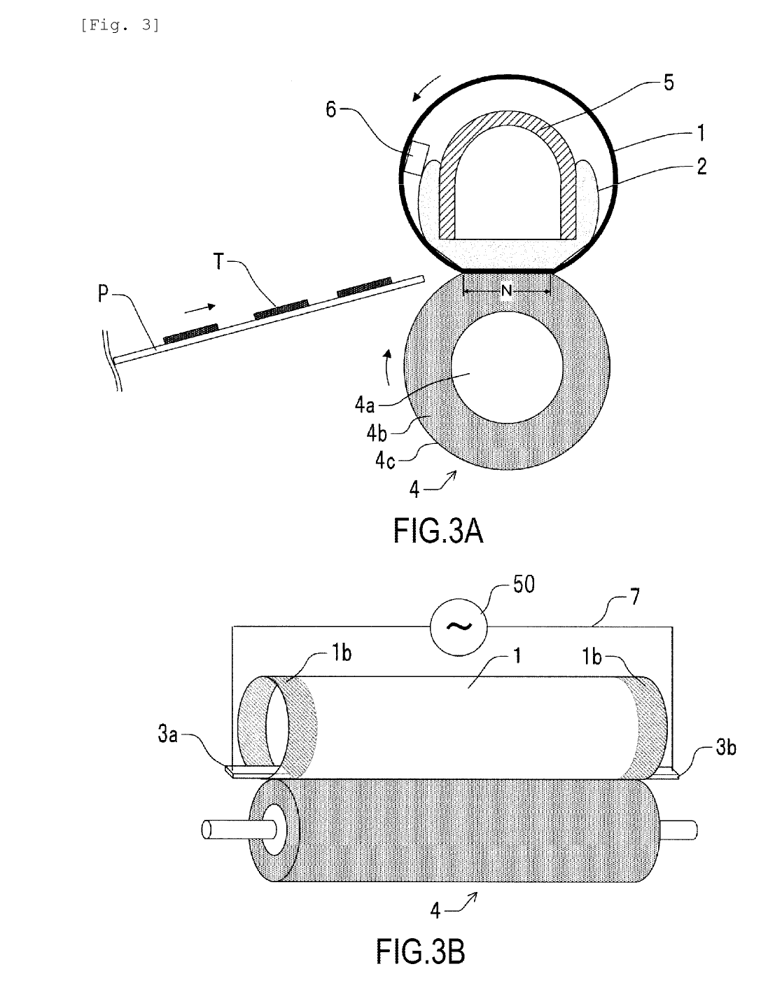

A configuration of a fixing film 1 in Embodiment 1 of the present invention will be described using FIG. 1A and FIG. 1B, FIG. 2A to FIG. 2C, and FIG. 3A and FIG. 3B. FIG. 1A and FIG. 1B are schematic diagrams illustrating arrangement of a low-resistance layer 1e as viewed from the front. FIG. 2A is a sectional view of a longitudinal end taken along line D1 in FIG. 1A and FIG. 1B. FIG. 2B and FIG. 2C are sectional views taken along lines D2 and D3 in FIG. 1A and FIG. 1B, respectively, depicting a portion of the fixing film 1 located close to a longitudinally central portion thereof and not including the low-resistance layer 1e and a portion of the fixing film 1 located close to a longitudinally central portion thereof and including the low-resistance layer 1e, respectively. FIG. 3A and FIG. 3B are sectional views taken along line D4 in a longitudinal direction in FIG. 1A and FIG. 1B.

As depicted in FIG. 1A and FIG. 1B, the fixing film 1 is a thin flexible cylindrical member having a cylindrical heat generating layer 1a. The fixing film 1 has a laminate structure. Conductive layers 1b are formed at respective opposite ends of the heat generating layer 1a all along a circumference thereof, and has a smaller volume resistivity than the heat generating layer 1a. Moreover, on the heat generating layer, the linear low-resistance layer 1e, which has a smaller volume resistivity than the heat generating layer 1a, is provided. The conductive layers 1b have a first conductive layer provided at one end of the heat generating layer 1a in the longitudinal direction of the fixing film and a second conductive layer provided at the other end of the heat generating layer 1a in the longitudinal direction of the fixing film. The low-resistance layer 1e extends in a direction crossing the longitudinal direction of the heat generating layer 1a, and in the illustrated example, extends along a circumferential direction of the heat generating layer 1a orthogonally to the longitudinal direction of the heat generating layer 1a.

The heat generating layer 1a is a base layer that provides the fixing film 1 with mechanical properties such as torsional strength and smoothness. The heat generating layer 1a is formed of a resin such as polyimide (PI), polyamideimide (PAI), or polyether ether keton (PEEK). A conductive filler that is carbon, metal, etc. is dispersed in the heat generating layer 1a such that an alternating current is applied through the conductive layer 1b to adjust electric resistance so as to allow heat generation.

For example, the heat generating layer 1a used is a polyimide film that has an outside diameter of ϕ18, a longitudinal length of 240 mm and a thickness of 60 μm and in which carbon is dispersed as the conductive filler. The heat generating layer 1a has a volume resistivity set to approximately 0.03 Ω·cm.

The conductive layers 1b are provided over a predetermined width, for example, within the range of approximately 10 mm, from the respective opposite ends of the fixing film 1 in the longitudinal direction in order to supply power to the heat generating layer 1a through an inner surface of the fixing film 1. In the present embodiment, silver paste is formed all over a surface of the heat generating layer 1a in the circumferential direction thereof as the conductive layer 1b for power feeding. In a specific example, the conductive layers 1b are silver paste with a volume resistivity of 4×10⁻⁵ Ω·cm. As the silver paste, silver particulates are dispersed in a polyimide resin using a solvent and then fired. When the conductive layers 1b are formed on the heat generating layer 1a, the value of resistance between the conductive layers 1b at the opposite ends of the heat generating layer 1a in the longitudinal direction is set to, for example, approximately 19.3Ω.

An elastic layer 1c is formed of silicone rubber that has a predetermined thickness and in which a thermally conductive filler is dispersed. A release layer 1d is subjected to a coating treatment with a fluorine resin, for example, PFA (tetrafluoroethylene perfluoroalkylvinylether copolymer) so as to be set to have a layer thickness of approximately 15 Jim. The elastic layer 1c and the release layer 1d are electrically insulated.

Furthermore, the present embodiment is characterized in that, besides the conductive layers 1b provided at the longitudinally ends for power feeding, a large number of endless low-resistance layers 1e each extending linearly in the circumferential direction are formed in the longitudinal direction in order to form an equipotential surface. That is, each of the linear low-resistance layers 1e is continuous in the circumferential direction and is shaped like an independent ring. In the present embodiment, the low-resistance layers 1e, used to form an equipotential surface, are formed of silver paste with a volume resistivity of 4×10⁻⁵ Ω·cm, which is the same as the silver paste of which the conductive layer 1b is formed. The volume resistance value of the low-resistance layers 1e with respect to the volume resistance value of the heat generating layer 1a is preferably within the range from 1/1000 to 1/00. Desirably, the low-resistance layers 1e is formed of a flexible material and has a thickness of 100 μm or less so as not to prevent the heat generating layer 1a from being deformed. The effects of the present example can be produced with the width of each low-resistance layer 1e set to any value so long as the width is appropriate to achieve conductivity. However, the width is desirably 5 μm or more in view of pattern chipping and stability of a line width. In the present embodiment, as depicted in FIG. 1A and FIG. 1B, a large number of the low-resistance layers 1e with an equal thickness and an equal width are arranged at equal intervals and equal pitches in the longitudinal direction between the conductive layers 1b provided at the ends. The low-resistance layers 1e are provided so as not to contact the conductive layers 1b. Specific dimensions are such that the interval and the width are set to 0.4 mm and 0.1 mm, respectively, and that the pitch and the thickness are set to 0.5 mm and approximately 10 μm, respectively.

Since a current passes through the low-resistance layers 1e extending in the circumferential direction in an endless manner, areas in which the respective low-resistance layers 1e are formed each generate a smaller amount of heat than each area of the heat generating layer 1a between adjacent low-resistance layers 1e with the low-resistance layer 1e not formed therein. Consequently, an excessively large width of the low-resistance layer 1e is likely to lead to nonuniform temperatures on the surface of the fixing film 1. Thus, each low-resistance layer 1e is desirably 0.1 mm or more and 5 mm or less in width. Furthermore, the interval between the low-resistance layers is desirably smaller than a circumferential length of the heat generating layer 1a (in the present embodiment, 57 mm). Moreover, a smaller interval between the low-resistance layers 1e allows the effects of the present embodiment to be more easily exerted but makes normal heat generating areas smaller. This results in a higher likelihood of a fluctuation in resistance caused by a variation in coating of the low-resistance layers 1e and joining of the adjacent low-resistance layers 1e. For example, when the adjacent low-resistance layers 1e are partly joined together, a reduced current flows through the heat generating layer 1a between these low-resistance layers 1e. Then, no heat is generated in this area, resulting in uneven heat generation. To ensure the above-described balance, the specific dimension of the interval between the low-resistance layers 1e is preferably set to 0.2 mm or more.

In the present embodiment, if the heat generating layer 1a has an actual resistance value of 18.0Ω at the opposite ends thereof in the longitudinal direction when the conductive layers 1b and the low-resistance layers 1e are formed on the heat generating layer 1a, the heat generating layer 1a has an actual resistance value of 19.3Ω at the opposite ends thereof in the longitudinal direction when only the conductive layers 1b are formed on the heat generating layer 1a. Formation of the low-resistance layers 1e reduces the total resistance of the fixing film 1 by 1.3Ω.

Furthermore, in the present embodiment, the conductive layers 1b for power feeding and the conductive rings 1e for equipotential-surface formation are provided on the same surface. However, conductive layers 1b for power feeding and the low-resistance layers 1e for equipotential-surface formation may be provided on different surfaces, for example, the conductive layers 1b are provided on an inner surface, whereas the low-resistance layers 1e are provided on an outer surface. Additionally, in the present embodiment, the low-resistance layers 1e are formed by printing the silver paste. However, the low-resistance layers 1e may be formed by any other means such as metal plating or sputtering.

(Description of the Fixing Apparatus)

Now, a configuration of a fixing apparatus that is a heating apparatus in Embodiment 1 of the present invention will be described using FIG. 3A and FIG. 3B. FIG. 3A is a sectional view of a longitudinally central portion of the fixing apparatus, and FIG. 3B is a schematic diagram of the fixing apparatus as viewed in the longitudinal direction.

The fixing apparatus is configured to heat and fix a toner image T formed on a recording material using a general electrophotographic image forming method. That is, the fixing apparatus includes a cylindrical fixing film 1 serving as a heating rotating member, a film guide 2 that holds an inner peripheral surface of the fixing film 1, and a pressurizing roller 4 that forms a nip N between the pressurizing roller 4 and the film guide 2 via the fixing film 1. Then, the recording material P bearing the toner image T is conveyed from a left side in FIG. 3A by conveying means not depicted in the drawings, sandwiched and conveyed through the nip N, and pressurized and heated to heat and fix the toner image T to the recording material P.

The film guide 2 is formed of a heat resistant resin such as a liquid crystal polymer, PPS, or PEEK and engaged, at opposite ends of the film guide 2 in the longitudinal direction, with a fixing stay 5 held by an apparatus frame. A pressurizing spring (not depicted in the drawings) serving as pressurizing means pressurizes the fixing stay 5 at the opposite ends thereof in the longitudinal direction to pressurize the film guide 2 toward the pressurizing roller 4. In order to transmit, in the longitudinal direction of the film guide 2, the pressure received at the opposite ends in the longitudinal direction evenly, the fixing stay 5 has a high rigidity increased by forming the fixing stay 5 using a rigid material such as iron, stainless steel, or a zinc chromate coat steel plate such that the fixing stay 5 has a U-shaped section. Consequently, with possible deflection of the film guide 2 suppressed, the fixing nip N is formed which has a uniform predetermined width in the longitudinal direction of the pressurizing roller 4. Furthermore, a temperature sensing element 6 is installed on the film guide 2 and is in abutting contact with an inner surface of the fixing film 1. Conduction of a current through the fixing film 1 is controlled according to a temperature detected by the temperature sensing element 6.

The low-resistance layers 1e of the fixing film 1 are desirably provided in a paper passing area for the recording material P that has at least the minimum width at which the recording material P can pass through the paper passing area.

In the present embodiment, a liquid crystal polymer is used as a material for the film guide 2, and a zinc chromate coat steel plate is used as a material for the fixing stay 7. A pressurizing force applied to the pressurizing roller 4 is 160 N, and at this time, the fixing nip N is formed to be approximately 6 mm in size.

The pressurizing roller 4 includes a cored bar 4a formed of a material such as iron or aluminum, an elastic layer 4b formed of a material such as silicone rubber, and a release layer 4c formed of a material such as PFA. The pressurizing roller 4 preferably has a hardness of approximately 40° to 70° under a 1-kgf load as measured using an ASKER-C durometer, so as to achieve appropriate durability and an appropriate fixing nip N width for satisfactory fixability.

Specifically, a silicone rubber layer is formed on the iron cored bar 4a of ϕ11 to a thickness of 3.5 t as the elastic layer 4b and then coated with an insulating PFA tube with a thickness of 40 μm as the release layer 4c. The pressurizing roller 4 has a surface hardness of 56° and an outside diameter of ϕ18. The elastic layer 4b and the release layer 4c have a longitudinal length of 240 mm.

Furthermore, power feeding members 3a, 3b are connected to an AC power supply 50 through AC cables 7 and disposed inside the fixing nip N at the opposite ends thereof so as to be pressed toward and against the pressurizing roller 4. In the present embodiment, as the power feeding members 3a, 3b, carbon brushes are used which are formed of metal graphite containing approximately 60% of copper. An AC voltage from the AC power supply 50 is applied to the carbon brushes via the AC cables 7 to achieve power feeding to the ends of the heat generating layer 1a of the fixing film 1. The power feeding members 3a, 3b are pressed against the rubber of the pressurizing roller 4 over a width of 6 mm in a conveying direction so as to protrude into the fixing nip N to a position 6 mm away from each of the opposite ends of the fixing nip N.

In the present embodiment, the conductive layers 1b are provided at the respective opposite ends of the heat generating layer 1a of the fixing film 1. This allows suppression of nonuniform heating in the circumferential direction of the fixing film 1. This is because the resistance value of the heat generating layer 1a of the fixing film 1 is much smaller in a thickness direction than in the longitudinal direction, causing a current from the power feeding members 3a, 3b to pass through the heat generating layer 1a in the thickness direction and then to uniformly flow all along the circumference of the heat generating layer 1a via the conductive layers 1b. The heat generating layer 1a has a resistance value of several m Ω in the thickness direction, and thus, the heat generation in this direction is not important. Furthermore, power is fed not from an outer peripheral side of the fixing film 1 around which the conductive layer 1b is formed but from an inner peripheral side of the fixing film 1, preventing the conductive layers 1b from being scraped by the power feeding members 3a, 3b. Thus, stable power feeding can be achieved through durability.

A turning force from a driving mechanism portion not depicted in the drawings is transmitted to a driving gear G for the pressurizing roller 4, and then the pressurizing roller 4 is rotationally driven at a predetermined speed in a counterclockwise direction as depicted in FIG. 3A and FIG. 3B. In conjunction with the rotational driving by the pressurizing roller 4, a frictional force is exerted between the pressurizing roller 4 and the fixing film 1 at the fixing nip portion N, causing a turning force to act on the fixing film 1. Consequently, the inner surface of the fixing film 1 comes into close contact with the film guide 2, and while sliding on the film guide 2, the fixing film 1 externally rotates around the film guide 2 counterclockwise as depicted in FIG. 3A and FIG. 3B, in conjunction with rotation of the pressurizing roller 4.

Rotation of the pressurizing roller 4 rotates the fixing film 1 to allow a current to conduct through the fixing film 1, elevating the temperature of the fixing film 1 to a predetermined value. Then, based on temperature information acquired by the temperature sensing element 6, the temperature is controlled. A recording material P with an unfixed toner image T is introduced, and at the fixing nip portion N, a toner image bearing surface of the recording material P is sandwiched and conveyed through the fixing nip portion N along with the fixing film 1. During this sandwiched conveyance process, the recording material P is heated by heat from the fixing film 1, and the unfixed toner image T on the recording material P is heated ad pressurized and thus melted and fixed onto the recording material P. The recording material P having passed through the fixing nip portion N is curved and separated from the surface of the fixing film 1 and discharged. The discharged recording material P is conveyed by a discharging roller pair not depicted in the drawings.

### Effects of Embodiment 1

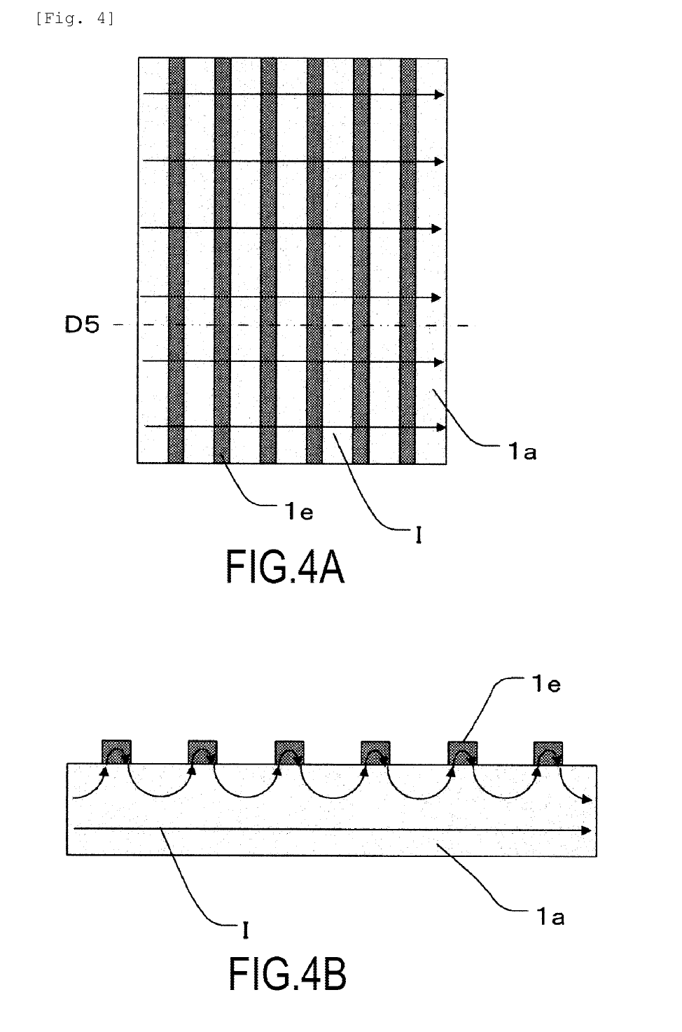

FIG. 4A and FIG. 4B are schematic diagrams depicting flows of currents through the fixing film 1 in Embodiment 1. FIG. 4A is a front schematic diagram of the longitudinally central portion of the fixing film 1. FIG. 4B is a sectional schematic diagram of the fixing film 1 in FIG. 4A taken along line D5 in the thickness direction. FIG. 4A and FIG. 4B illustrate only the heat generating layer 1a and the low-resistance layers 1e, and illustration of the other portions is omitted.

In a normal state where no crack C is formed, currents I flow in the longitudinal direction as depicted in FIG. 4A. In the normal state as depicted in FIG. 4A, substantially no current flows through the low-resistance layer 1e in the circumferential direction unless the thickness or resistivity of the heat generating layer 1a varies. In the thickness direction, the currents I flow such that currents flowing near the surface of the heat generating layer 1a flow mainly through the low-resistance layers 1e in portions of the heat generating layer 1a where the respective low-resistance layers 1e are formed and uniformly through the heat generating layer 1a in portions thereof where no low-resistance layer 1e is formed, as depicted in FIG. 4B. Currents flowing through the low-resistance layers 1e do not substantially contribute to heat generation due to the small resistance of each low-resistance layer 1e. The portions of the heat generating layer 1a where no low-resistance layer 1e is formed significantly contribute to heat generation.

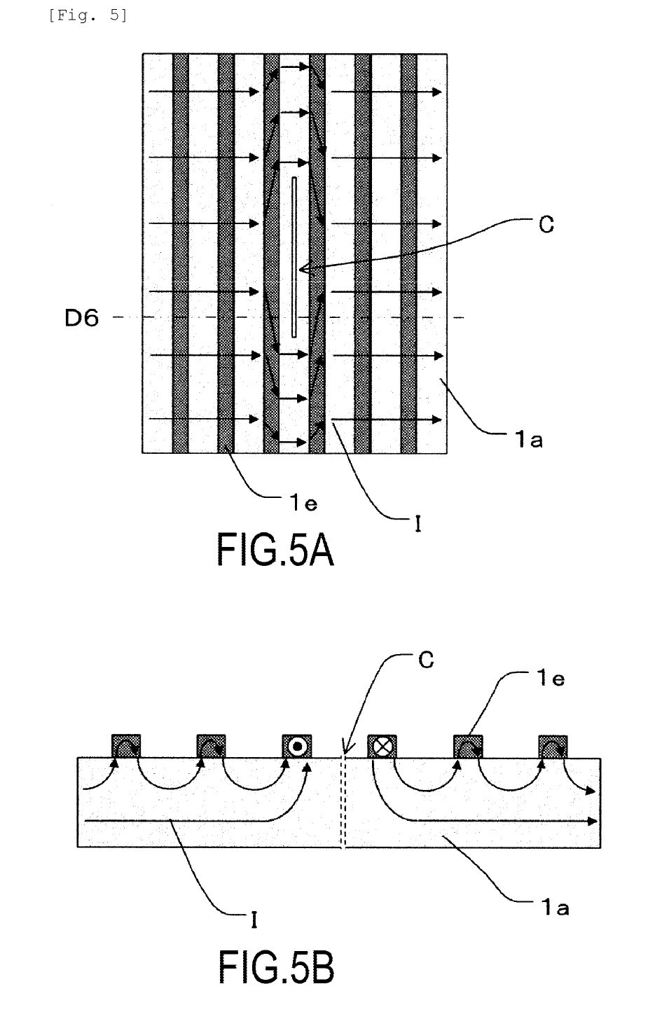

Now, a crack C is assumed to be formed in the fixing film 1. FIG. 5A is a front schematic diagram illustrating that the crack C is formed in the fixing film 1 in FIG. 4A. FIG. 5B is a sectional schematic diagram of the fixing film 1 in FIG. 5A taken along line D6 in the thickness direction.

In such a case, with no low-resistance layer 1e, flows of the currents I are blocked by the crack C, and thus, the currents I bypass the crack portion C, causing abnormal heat generation near ends of the crack C.

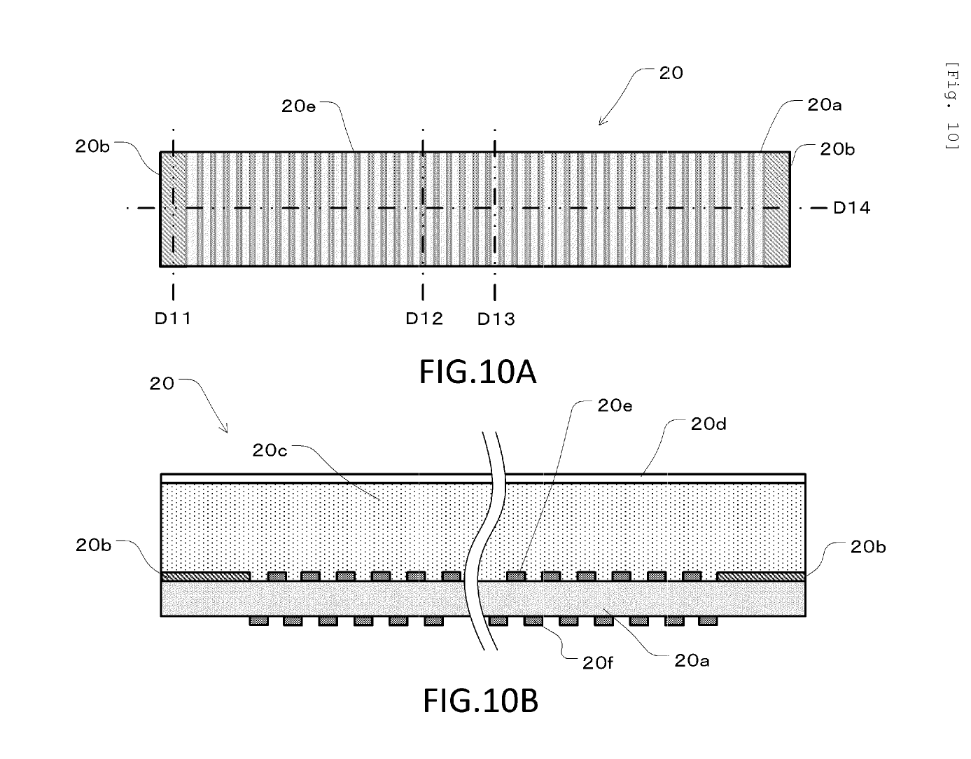

FIG. 10A and FIG. 10B are referential drawings illustrating that when, with no low-resistance layer 1e, a crack C is formed as a result of damage to the heat generating layer 1a, currents concentrate near the ends of the crack.

Reference characters I1 to I4 denote currents flowing through the heat generating layer 1a at a certain point of time. Provision of the conductive layers 1b allows currents to flow uniformly, in the normal state, through the heat generating layer 1a of the fixing film 101 in the longitudinal direction, enabling uniform heat generation.

However, as depicted in FIG. 10A and FIG. 10B, when a crack C is formed as a result of damage to the heat generating layer 1a, the crack C blocks traveling of currents I2, I3, and the currents I2, I3 flow around the ends of the crack portion C to bypass the crack C. Thus, in areas A, B around the ends, a current density increases at one point in a concentrated manner, leading to local abnormal heat generation at that point.

The portion where abnormal heat generation has occurred has a much higher temperature than the normal portions, increasing the likelihood that the fixing film 1 will be thermally damaged or inappropriate images will be formed.

In contrast, in Embodiment 1, since a large number of the low-resistance layers 1e for equipotential surface formation are formed, even when a crack C is generated, the currents I bypass the crack C by passing through the low-resistance layers 1e as depicted in FIG. 5A. As a result, the currents I are prevented from bypassing the crack C in the heat generating layer 1a as in the referential example, and in the heat generating layer 1a between the low-resistance layers 1e, flow in a direction perpendicular to edges of the low-resistance layers 1e, that is, in the longitudinal direction. Since the low-resistance layers 1e offer sufficiently low resistance than the heat generating layer 1a, the amount of heat generated in the low-resistance layers 1e as a result of the currents passing through the low-resistance layers 1e is small and not important.

Given the thickness direction as in FIG. 5B, a current having reached the low-resistance layer 1e in front of the crack C flows through the low-resistance layer 1e in a direction perpendicular to the sheet of FIG. 5B, bypasses the crack C, then flows into the next low-resistance layer 1e, and returns to a current path similar to the normal current path. The above-described mechanism enables a reduction in local current concentration in the heat generating layer 1a caused by the crack C.

The low-resistance layers 1e are desirably continuous in the circumferential direction. However, the effects of the present invention can be exerted even when the low-resistance layer 1e are partly discontinued. In other words, the linear low-resistance layers 1e are desirably provided which extend in the direction orthogonal to the currents flowing in the longitudinal direction of the fixing film 1, or in the circumferential direction. However, the direction of the low-resistance layers 1e is not limited to the orthogonal direction, but the effects of the present invention can be exerted even when the low-resistance layers 1e are inclined to the currents so long as the low-resistance layers 1e extend in a direction traversing the currents. The currents flow between the conductive layers 1b provided at the opposite ends of the fixing film 1 in the longitudinal direction.

Furthermore, in the present embodiment, the low-resistance layers 1e are formed all over an area of the fixing film 1 over which the recording material P can be passed. Thus, wherever in the heat generating layer 1a in the longitudinal direction a crack is formed as a result of foreign matter, a staple, or the like that rushes into the fixing apparatus along with the recording material P, abnormal heat generation can be reduced.

As described above, in Embodiment 1, a plurality of the low-resistance layers 1e, which offers lower resistance than the heat generating layer 1a, is formed on the heat generating layer 1a so as to traverse the currents flowing through the heat generating layer 1a. This configuration enables a reduction in local current concentration when the heat generating layer 1a is cracked, resulting in a reduction in abnormal heat generation.

In the present example, the conductive layers are provided. However, the present invention is not limited to this configuration. Any configuration is possible so long as the low-resistance layers are formed in the areas of the heat generating layer at least except for one end and the other end of the heat generating layer.

### Embodiment 2

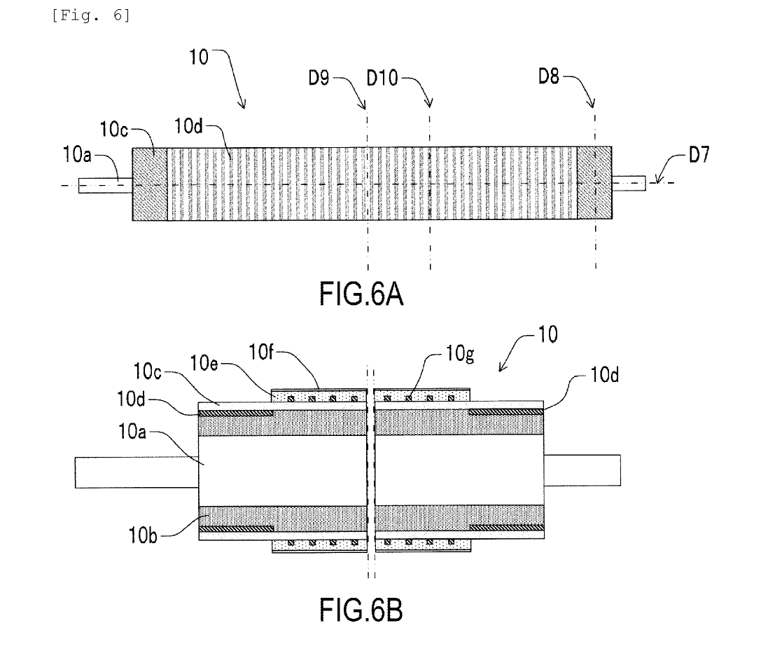

Now, Embodiment 2 of the present invention will be described with reference to FIG. 6A to FIG. 8B. Embodiment 2 uses a fixing roller as a heating rotating member.

Also in the present embodiment, first, a configuration of a fixing roller will be described, and then, a fixing apparatus using the fixing roller will be described.

### (Description of the Fixing Roller)

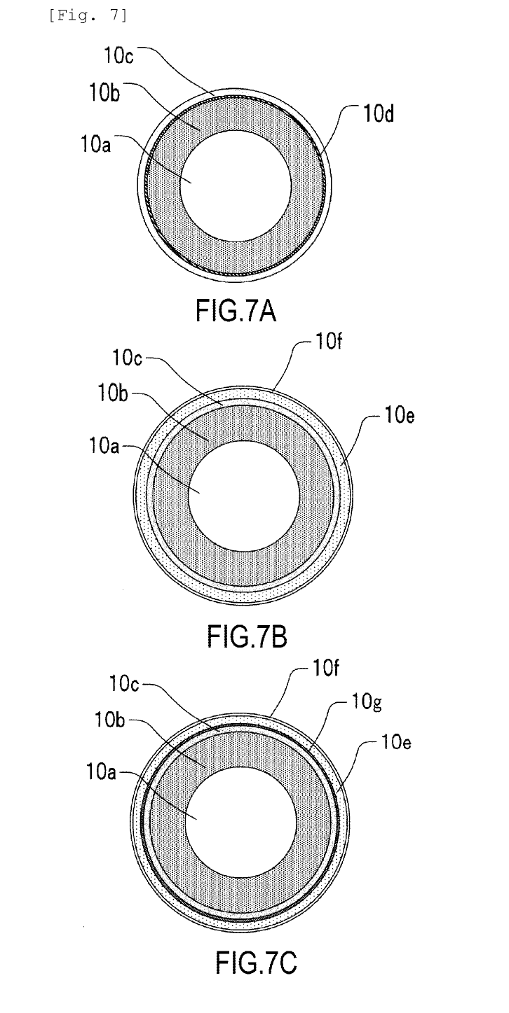

FIG. 6A is a front schematic diagram of the fixing roller. FIG. 6B is a sectional schematic diagram of the fixing roller in FIG. 6A taken along line D7. Furthermore, FIG. 7A is a sectional schematic diagram of the fixing roller in FIG. 6A taken along line D8. FIG. 7B is a sectional schematic diagram of the fixing roller in FIG. 6A taken along line D9. FIG. 7C is a sectional schematic diagram of the fixing roller in FIG. 6A taken along line D10.

The fixing roller 10 has a cored bar 10a serving as a rotating shaft, a sponge rubber layer 10b shaped like a roller arranged concentrically and integrally around the cored bar 10a and serving as an elastic layer, and a heat generating layer 10c provided on the sponge rubber layer and containing, for example, resin provided with conductivity by adding a conductive filler to the resin. Moreover, conductive layers 10d for power feeding having a predetermined width are formed on an inner surface of the heat generating layer 10c at respective opposite ends thereof. The width of each of the conductive layers 10d are set to, for example, approximately 10 mm. An elastic layer 10e and a release layer 10f are provided on the heat generating layer 10c. Furthermore, besides the conductive layers 10d provided on the heat generating layer 10c at the respective opposite ends thereof for power feeding, a large number of linear low-resistance layers 10g extending in the circumferential direction and configured to form an equipotential surface are formed along the longitudinal direction.

In a specific example, for example, a cored bar 10a formed of stainless steel and having an outside diameter of 11 mm was used, and for the sponge rubber layer 10b, an open-cell sponge rubber was used which was formed by containing resin balloons and a foaming agent in solid silicone rubber and vaporizing the foaming agent to join the resin balloons together. The heat generating layer 10c was the same as the heat generating layer 1a used for the fixing film 1 in Embodiment 1. The conductive layers 10d for power feeding were formed of the same material as that in Embodiment 1 and had the same thickness as that in Embodiment 1. However, the conductive layers 10d are formed on the inner surface of the heat generating layer 10c because the fixing roller 10 feeds power through an outer peripheral surface thereof. The elastic layer 10e and the release layer 10f were also formed of the same materials as those in Embodiment 1 and had the same thicknesses as those in Embodiment 1. However, the 10-mm areas at the longitudinally opposite ends are not formed because power is fed to the heat generating layer 10c through ends of the outer peripheral surface of the fixing roller 10. Areas from which the heat generating layer 10c is exposed are contact areas to which power is fed by the power feeding members. The low-resistance layers 10g were also formed of the same material as that in Embodiment 1, had the same thickness and width as those in Embodiment 1, and were formed on the heat generating layer 10c between the conductive layers 10d at the same intervals as those in Embodiment 1.

Desirably, the fixing roller 10 in the present embodiment has an outside diameter of, for example, approximately 18 mm, and has a hardness of 30° to 70° under a load of 5.9 N as measured using an ASKER-C durometer, so as to achieve an appropriate fixing nip N and appropriate durability. Specifically, the hardness was set to 52°. Furthermore, as in the case of Embodiment 1, the heat generating layer 10c is 240 mm in length.

(Description of the Fixing Apparatus)

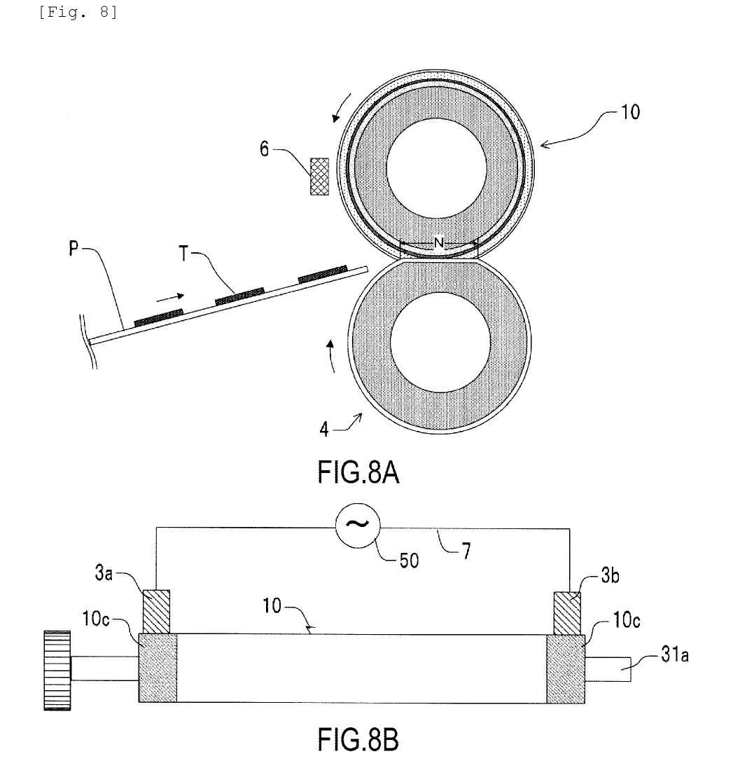

FIG. 8A is a sectional schematic diagram of a main part of a fixing apparatus in Embodiment 2. FIG. 8B is a front schematic diagram of the fixing apparatus.

The fixing apparatus in Embodiment 2 includes a cylindrical fixing roller 10 serving as a heating rotating member and a pressurizing roller 4 serving as a pressurizing member that forms a fixing nip N in cooperation with the fixing roller 10.

The fixing roller 10 and the pressurizing roller 4 are pressurized by pressuring means depicted in the figures to form a fixing nip N with a predetermined width that is uniform in the longitudinal direction of the pressurizing roller 4. Furthermore, a non-contact temperature sensing element 6 is installed on the surface of the fixing roller 10 to detect the temperature of the fixing roller 10. Conduction of a current through the fixing roller 10 is controlled according to the temperature detected by the temperature sensing element 6.

Power feeding members 3a, 3b are connected to an AC power supply 50 through AC cables 7 and disposed at ends of the fixing nip N located at the respective opposite portions thereof so as to be pressed toward and against the fixing roller 10. In the present embodiment, carbon brushes formed of metal graphite were used as the power feeding members 3a, 3b as is the case with Embodiment 1. An AC voltage from an AC power supply 50 is applied to the carbon brushes via the AC cables 7 to achieve power feeding to the ends of the heat generating layer 1a of the fixing film 1.

Specifically, the power feeding members 3a, 3b were pressed against the heat generating layer 1c of the fixing roller 10 over a width of 6 mm in the longitudinal direction and over a width of 6 mm in the conveying direction at a pressurizing force of 4 N.

A turning force from a driving mechanism portion not depicted in the drawings is transmitted to a driving gear G attached to the fixing roller 10, which is then rotationally driven at a predetermined speed in a counterclockwise direction as depicted in FIG. 8A. In conjunction with the rotational driving by the fixing roller 10, a frictional force is exerted between the fixing roller 10 and the pressurizing roller 4 at the fixing nip portion N, causing a turning force to act on the pressurizing roller 4. Consequently, the pressurizing roller 4 is driven and rotated.

A current is conducted through the fixing roller 10 to elevate the temperature of the fixing film 10 to a predetermined value. Then, the temperature is controlled by the temperature sensing element 6. A recording material P with an unfixed toner image T is introduced, and at the fixing nip portion N, a toner image bearing surface of the recording material P is sandwiched and conveyed through the fixing nip portion N along with the fixing film 1. Then, a fixing operation is performed. The recording material P having passed through the fixing nip portion N is curved and separated from the surface of the fixing film 1 and discharged. The discharged recording material P is conveyed by a discharging roller pair not depicted in the drawings.

### Effects of Embodiment 2

Also in Embodiment 2, a large number of the linear low-resistance layers 10g offering lower resistance than the heat generating layer 10c are formed on the heat generating layer 10c so as to traverse currents flowing through the heat generating layer 10c. In this configuration, a mechanism similar to the mechanism in Embodiment 1 enables a reduction in local current concentration when a crack C is formed in the heat generating layer 10c, resulting in a reduction in abnormal heat generation.

Furthermore, in Embodiment 2, the heat generating layer 10c is bonded to and backed up by the sponge rubber layer 10b and unlike in Embodiment 1 in which the heat generating layer 10c is shaped like a film. Thus, even if the heat generating layer 10c is damaged by a flaw, Embodiment 2 enables a reduction in the likelihood that the damage will be developed as a result of the subsequent use. This in turn enables a further reduction in the likelihood of abnormal heat generation.

In the present embodiment, the pressurizing roller 4 is used as the pressurizing member. However, for example, a pressurizing film unit using a driven pressuring film may be used as the pressurizing member.

### Embodiment 3

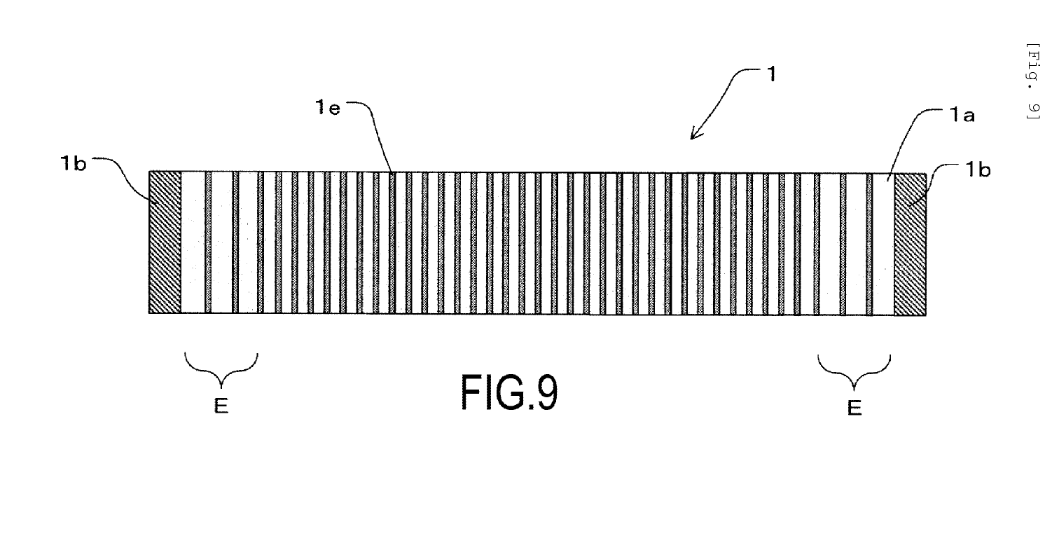

Now, Embodiment 3 of the present invention will be described using FIG. 9.

In Embodiment 3, a large number of the low-resistance layers 1e for equipotential surface formation are formed as is the case with Embodiment 1. However, in the present embodiment, a heat generation distribution is varied in the longitudinal direction by setting the low-resistance layers 1e to have the same width but varying the interval between the low-resistance layers 1e in the longitudinal direction. The remaining part of the configuration of Embodiment 3 is similar to the corresponding part of the configuration of Embodiment 1, and will thus not be described.

In areas where the respective conductive layers 1b for power feeding are formed, substantially all the currents pass through the conductive layer 1b. Thus, the areas with the conductive layers 1b are substantially prevented from generating heat. Consequently, when a certain amount of time has elapsed since the start of temperature control, heat may travel to the ends of the fixing film 1, and temperature sagging may occur in which the temperature becomes lower in areas E of the fixing film 1 at the opposite ends thereof in the longitudinal direction than in the central portion of the fixing film 1 in the longitudinal direction. Prevention of this phenomenon can be achieved by increasing a heat generation density in the areas E. To change the heat generation density, means may be used, such as changing the thickness or the volume resistivity of the heat generating layer 1a only in the areas E. However, this may, for example, affect the strength of the fixing film 1 or make manufacturing difficult.

In Embodiment 3, the intervals at which the low-resistance layers 1e are formed are increased only in the areas E, each of which is located inside the area where the conductive layer 1b is formed. Specifically, only for the low-resistance layers 1e in each area E, which is 10 mm in size, the interval between the low-resistance layers 1e is changed from 0.4 mm to 0.9 mm with the width of each low-resistance layer 1e kept at 0.1 mm. As described in Embodiment 1, each low-resistance layer 1e has a lower volume resistivity than the heat generating layer 1a. Thus, the area where the low-resistance layers 1e are formed has a lower resistance and a lower heat generation density than the area where no low-resistance layer 1e is formed. When low-resistance layers 1e with a 0.9 mm interval and each with a width of 0.1 mm were formed all over the fixing film 1 in the longitudinal direction thereof, the fixing film 1 had a total resistance value of 18.7Ω. As described in Embodiment 1, when low-resistance layers 1e with a 0.4 mm interval and each with a width of 0.1 mm are formed all over the fixing film 1 in the longitudinal direction thereof, the fixing film 1 has a resistance value of 18.0Ω. In the areas E where the interval between the low-resistance layers 1e is locally increased to 0.9 mm, the resistance value is approximately 4% larger than the resistance value in the other portions of the fixing film 1, and thus, the amount of heat generated can accordingly be increased.

In Embodiment 3, the resistance is adjusted by varying the coating interval of the low-resistance layers 1e. However, the resistance can be adjusted by varying a coating width of low-resistance layers 1e, that is, the width of the low-resistance layers. In that case, portions where the low-resistance layers 1e have a smaller width have a relatively large amount of heat generated, whereas portions where the low-resistance layers 1e have a larger width have a relatively small amount of heat generated. Furthermore, both the interval and width of the low-resistance layers may be varied. In short, the heat distribution in the longitudinal direction can be adjusted by locally varying at least one of the width of each low-resistance layer 1e and the interval between the low-resistance layers 1e. As described above, in addition to producing the effects of Embodiment 1, Embodiment 3 allows the resistance to be adjusted by varying the coating interval or the coating width of the low-resistance layers 1e, enabling the heat generation distribution to be easily adjusted.

### Embodiment 4

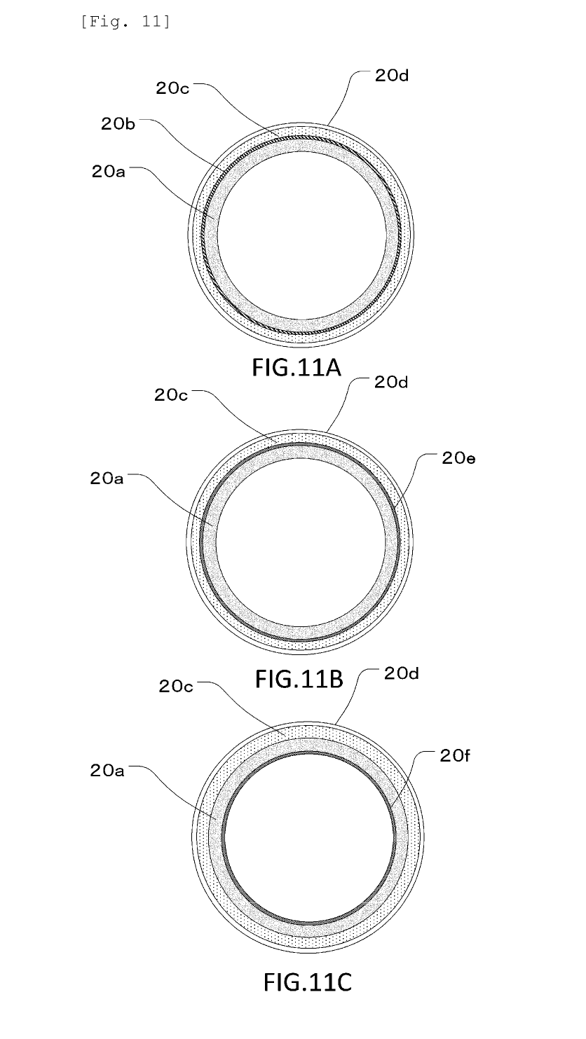

Now, a configuration of a fixing film 20 in Embodiment 4 of the present invention will be described using FIG. 10A and FIG. 10B and FIG. 11A to FIG. 11C. FIG. 10A is a schematic diagram illustrating arrangement of low-resistance layers 20e as viewed from the front. FIG. 11A is a sectional view of a longitudinal end of the fixing film 20 taken along line D11 in FIG. 10A. FIG. 11B and FIG. 11C are sectional views of a portion of the fixing film 20 near a longitudinally central portion thereof where the low-resistance layer 20e is provided on an outer surface and a portion of the fixing film 20 near the longitudinally central portion thereof where no low-resistance layer 20e is provided on the outer surface, taken respectively along lines D12 and D13 in FIG. 10A. FIG. 10B is a sectional view of the fixing film 20 taken along line D14 in FIG. 10A in the longitudinal direction. In Embodiment 4, a large number of the low-resistance layers 20e for equipotential surface formation are formed on the outer surface of a heat generating layer 20a as is the case with Embodiment 1. However, in the present embodiment, the low-resistance layers are also formed on an inner surface of the heat generating layer 20a, and low-resistance layers 20f on the inner surface are each formed on the opposite side of a portion of the heat generating layer 20a where no low-resistance layer 20e is present on the outer layer of the heat generating layer 20a.

The heat generating layer 20a is formed of a material offering higher resistance than in Embodiment 1. The volume resistivity of the heat generating layer 20a was adjusted to approximately 0.075 ∩·cm by dispersing carbon in polyimide. The thickness of the heat generating layer 20a was set to 75 μm. As a material for the low-resistance layers 20e, 20f, silver paste with a volume resistivity of 4×10⁻⁵ Ω·cm was used as is the case with Embodiment 1. For both the low-resistance layers 20e and 20f, the thickness was approximately 10 μm, both the interval and the width were 0.3 mm, and the pitch was 0.6 mm. The low-resistance layers 20e, 20f were formed such that the low-resistance layers 20e on the outer surface were shifted in phase from the low-resistance layers 20f on the inner surface by 0.3 mm. Conductive layers 20b, an elastic layer 20c, and a release layer 20d have configurations similar to the corresponding configurations in Embodiment 1 and will thus not be described.

In the present embodiment, the fixing film 20 has an actual resistance value of 17.8Ω at the opposite ends of the fixing film 20 in the longitudinal direction when the conductive layers 20b and the low-resistance layers 20e, 20f are formed on the heat generating layer 20a. The fixing film 20 has an actual resistance value of 36Ω at the opposite ends of the fixing film 20 in the longitudinal direction when only the conductive layers 20b are formed on the heat generating layer 20a. Thus, the total resistance of the fixing film 20 is reduced to approximately half by providing the low-resistance layers 20e, 20f on both surfaces of the heat generating layer 20a.

Furthermore, in the present embodiment, the low-resistance layers 20e on the outer surface and the low-resistance layer 20f on the inner surface are formed of the same silver paste. However, different materials may be used for the outer surface and for the inner surface so long as the materials have a smaller volume resistivity than the heat generating layer 20a.

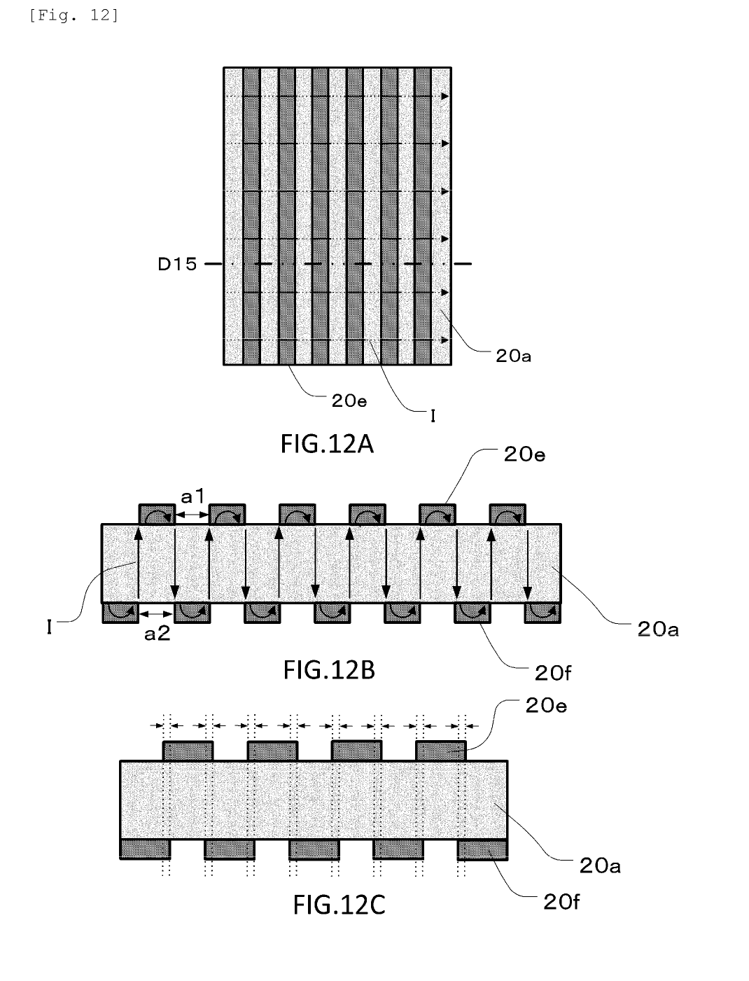

FIGS. 12A to 12C are schematic diagrams depicting flows of currents in the fixing film 20 in Embodiment 4. FIG. 12A is a front schematic diagram of a longitudinally central portion of the fixing film 20. FIG. 12B is a sectional schematic diagram of the fixing film 20 taken along line D15 in FIG. 12A in the thickness direction of the fixing film 20. FIG. 12A to FIG. 12C depict only the heat generating layer 20a and the low-resistance layers 20e, 20f, and illustration of the other portions is omitted.

In the normal state where no cracking occurs, currents I flow alternately in the thickness direction of the heat generating layer 20a and through the low-resistance layer 20e or 20f in the longitudinal direction as depicted in FIG. 12B. In the present example, the low-resistance layers 20e, 20f have the lowest volume resistivity, the interval a1 between the low-resistance layers 20e on the same surface of the heat generating layer 20a is 0.3 mm, the interval a2 between the low-resistance layers 20f on the same surface of the heat generating layer 20a is 0.3 mm, and the shortest distance between the low-resistance layers 20e and 20f on the opposite surfaces of the heat generating layer 20a is 75 μm which corresponds to the thickness of the heat generating layer 20a. Thus, the currents flow in the thickness direction of the heat generating layer 20a to cause the heat generating layer 20a to generate heat. The currents flowing through the low-resistance layers 20e, 20f do not contribute to heat generation due to the small resistance of the low-resistance layers 20e, 20f. When the interval between the low-resistance layers 20e, 20f on the same surface of the heat generating layer 20a is larger than the shortest distance between the low-resistance layers 20e and 20f on the opposite surfaces of the heat generating layer 20a (that is, the thickness of the heat generating layer 20a), the currents flow in the thickness direction of the heat generating layer 20a. When this relation is satisfied, the low-resistance layers 20e and 20f may have overlap areas as depicted by arrows in FIG. 12C in the thickness direction of the heat generating layer 20a.

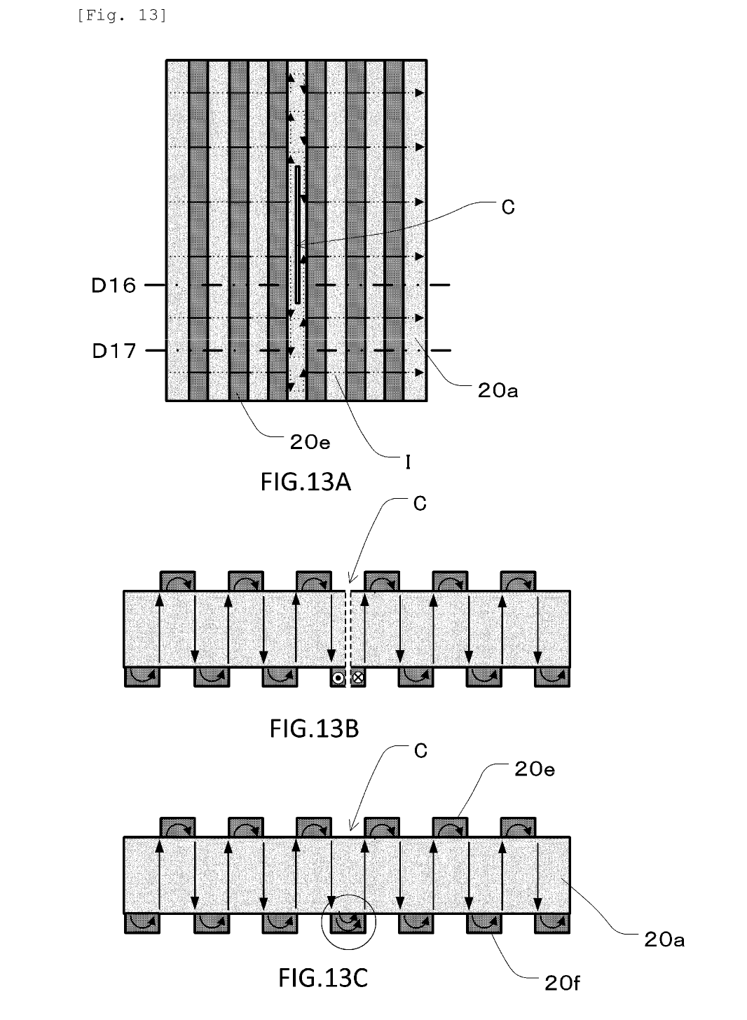

Now, a crack C is assumed to be formed in the fixing film 20. FIG. 13A is a front schematic diagram illustrating that the crack C is formed in the fixing film 20 in FIG. 12A. FIG. 13B is a sectional schematic diagram of the fixing film 20 in FIG. 13A taken along line D16 in a thickness direction of a cracked portion of the fixing film 20. FIG. 13C is a sectional schematic diagram of the fixing film 20 in FIG. 13A taken along line D17 in a thickness direction of a portion of the fixing film 20 where no cracking has occurred.

In the present example, the low-resistance layer is present at any portions of the heat generating layer on the outer surface or inner surface thereof. Thus, wherever in the heat generating layer the crack C is formed, paths of currents flowing through the low-resistance layers in the longitudinal direction of the fixing film 20 are inevitably present such as an encircled portion in FIG. 13C. In Embodiments 1 to 3, if a crack is formed in the heat generating layer between the low-resistance layers 1e as depicted in FIG. 5A and FIG. 5B, portions of the heat generating layer where no cracking has occurred in the same circumferential direction have a current density increased by the amount of currents bypassing the crack in the circumferential direction. Thus, although abnormal heat generation is prevented, the amount of heat generated by the portions where no cracking has occurred increases consistently with the length of the crack. In the present example, the currents bypassing the crack in the circumferential direction in FIG. 13B inevitably flow through the low-resistance layers, and only a small amount of heat is generated. Thus, the amount of heat generated by the portions where no cracking has occurred can be restrained from increasing.

As described above, in Embodiment 4, a plurality of the low-resistance layers 20e and 20f, which offer lower resistance than the heat generating layer 20a, are formed on the opposite surfaces of the heat generating layer 20a. The low-resistance layer is present at any positions of the heat generating layer 20a on the outer surface or the inner surface thereof. When the heat generating layer 20a is cracked, the configuration as described above enables a reduction in local current concentration, allowing possible abnormal heat generation to be prevented.

### Embodiment 5

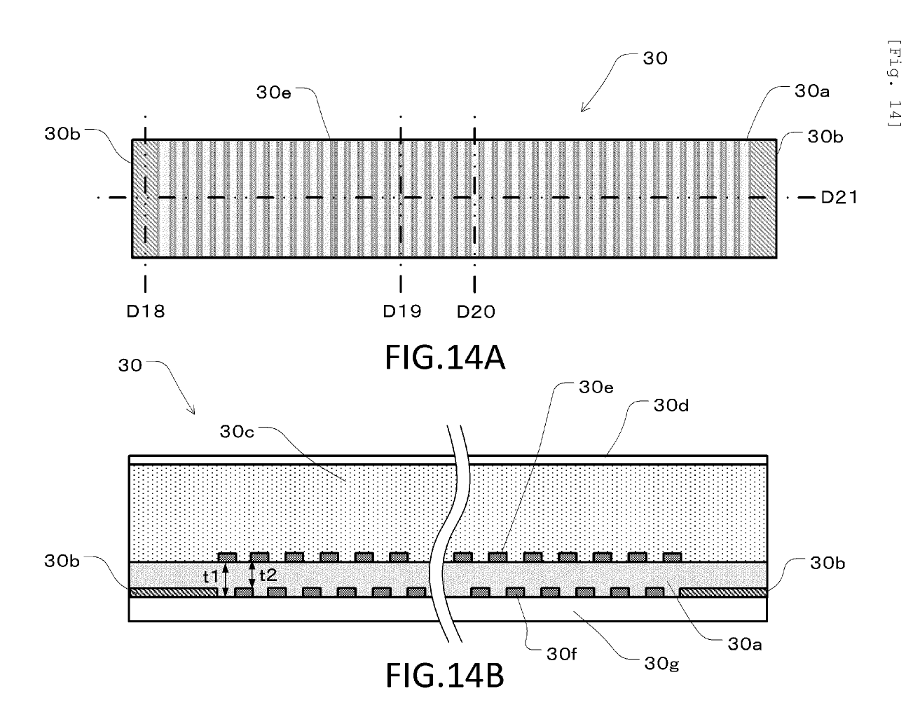

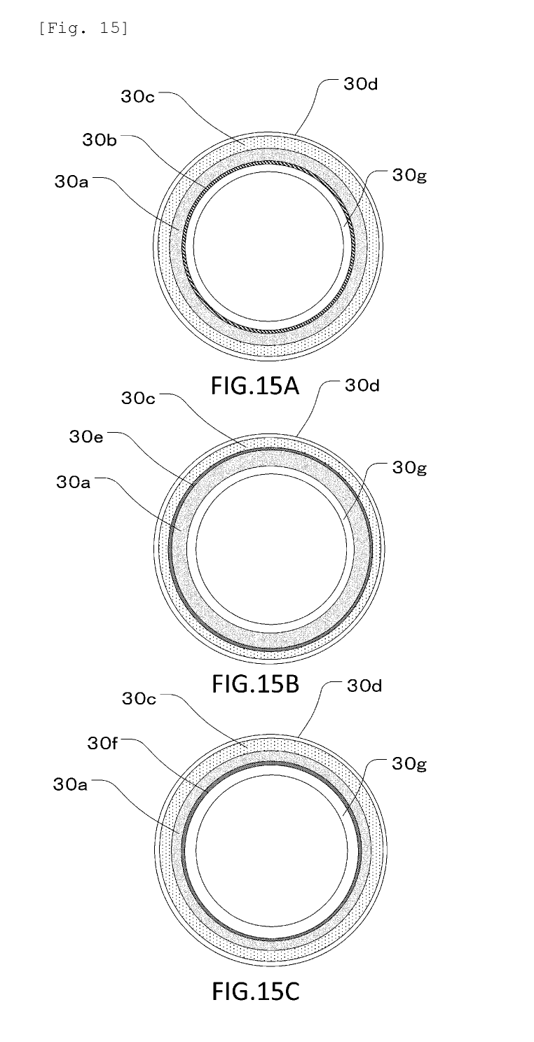

Now, a configuration of a fixing film 30 in Embodiment 5 of the present invention will be described using FIG. 14A and FIG. 14B and FIG. 15A to FIG. 15C. FIG. 14A is a schematic diagram illustrating arrangement of low-resistance layers 30e as viewed from the front. FIG. 15A is a sectional view of a longitudinal end of the fixing film 30 taken along line D18 in FIG. 14A. FIG. 15B and FIG. 15C are sectional views of a portion of the fixing film 30 near a longitudinally central portion thereof where the low-resistance layer 30e is provided on an outer surface and a portion of the fixing film 30 near the longitudinally central portion thereof where no low-resistance layer 30e is provided on the outer surface, taken along lines D19 and D20 in FIG. 14A. FIG. 14B is a sectional view of the fixing film 30 taken along line D21 in FIG. 14A in the longitudinal direction. In Embodiment 5, a high-resistance layer 30g is provided on the inner surface of the fixing film in Embodiment 4.

The high-resistance layer 30g is formed of a material offering higher resistance than a heat generating layer 30a. The volume resistivity of the high-resistance layer 30g was adjusted to approximately 0.3 Ω·cm by dispersing a slight amount of carbon in polyimide. The thickness of the high-resistance layer 30g was set to 50 μm. Then, conductive layers 30b and low-resistance layers 30f were formed on the high-resistance layer 30g, and the heat generating layer 30a was formed on the high-resistance layer 30g to a thickness of 85 μm. The heat generating layer 30a is formed of the same material as that of the heat generating layer 20a in Embodiment 4. A distance t1 in FIG. 14B represents the thickness of the heat generating layer 30a. Then, a layer configuration in the present embodiment can be obtained by firing the heat generating layer 30a and then forming low-resistance layers 30e on the heat generating layer 30a. Conductive layers 30b, an elastic layer 30c, and a release layer 30d have configurations similar to the corresponding configurations in Embodiment 4 and will thus not be described.

As a material for the low-resistance layers 30e on the heat generating layer 30a and the low-resistance layers 30f on the high-resistance layer 30g, silver paste with a volume resistivity of 4×10⁻⁵ Ω·cm was used as is the case with Embodiment 4. For the low-resistance layers 30e and 30f, the thickness was approximately 10 μm, both the interval and the width were 0.3 mm, and the pitch was 0.6 mm. The low-resistance layers 30e, 30f were formed such that the low-resistance layers 30e were shifted in phase from the low-resistance layers 30f by 0.3 mm. An interval t2 between the low-resistance layers 30e and 30f in the thickness direction of the heat generating layer 30a is 75 μm. The distance between the low-resistance layers on the same surface (30e-30e, 30f-30f) is 0.3 mm, and the distance between the low-resistance layers in the thickness direction (30e-30f) is 75 μm. Both distances are the same as the corresponding distances in Embodiment 4, meaning that the resistance value in Embodiment 5 is the same as the resistance value in Embodiment 4.

Furthermore, in the present embodiment, the low-resistance layers 30e on the heat generating layer 30a and the low-resistance layers 30f on the high-resistance layer 30g are formed of the same silver paste. However, different materials may be used for the low-resistance layers 30e and for the low-resistance layers 30f so long as the materials have a smaller volume resistivity than the heat generating layer 30a.

In Embodiment 4, if the low-resistance layers are formed on the inner surface of the fixing film, since the fixing film inner surface is rubbed by the film guide 2 or the temperature sensing element 6 illustrated in FIG. 3A and FIG. 3B, the low-resistance layers may be worn off. If the wear of the low-resistance layers progresses to partly eliminate the low-resistance layers, the effects of the present invention fail to be produced. Thus, the low-resistance layers can be prevented from being worn off by providing the high-resistance layer on the fixing film inner surface as a protective layer as in Embodiment 5.

Embodiments 4 and 5 described above may be applied to the fixing roller described in Embodiment 2. Furthermore, in Embodiments 4 and 5, the width and the interval of the low-resistance layers are the same for the inner peripheral surface and for the outer peripheral surface. However, the width and the interval of the low-resistance layers may locally vary as disclosed in Embodiment 3 by way of example. The effects of the invention in Embodiments 4 and 5 can be produced so long as, in the thickness direction of the heat generating layer, the low-resistance layer is present at any positions of the heat generating layer on the outer surface or the inner surface thereof.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-125037, filed on Jun. 22, 2015 and Japanese Patent Application No. 2016-113423, filed on Jun. 7, 2016, which are hereby incorporated by reference herein in their entirety.

1. A tubular film used for a fixing apparatus, the film comprising:
a heat generating layer;
a first conductive layer and a second conductive layer provided respectively at one end and another end of the film in a longitudinal direction of the film so as to contact the heat generating layer, the first conductive layer and the second conductive layer both having a lower volume resistivity than that of the heat generating layer; and
a low-resistance layer formed in an area of the heat generating layer between the first conductive layer and the second conductive layer in the longitudinal direction so as not to contact the first conductive layer and the second conductive layer, the low-resistance layer having a lower volume resistivity than that of the heat generating layer, and extending in a circumferential direction of the heat generating layer.

2. The film according to claim 1, wherein the low-resistance layer is an annular layer.

3. The film according to claim 1, wherein the conductive layers are annular layers extending in the circumferential direction of the heat generating layer.

4. The film according to claim 1, wherein a plurality of the low-resistance layers are provided at intervals.

5. The film according to claim 1, wherein a volume resistivity of the low-resistance layer with respect to the volume resistivity of the heat generating layer is between 1 to 1000 and 1 to 100.

6. The film according to claim 1, wherein a thickness of the low-resistance layer is 5 μm or more to 100 μm or less.

7. The film according to claim 4, wherein an interval between the adjacent low-resistance layers is 0.2 mm or more to a value equal to or less than a circumferential length of the heat generating layer.

8. The film according to claim 1, wherein a width of the low-resistance layer is 0.1 mm or more to 5 mm or less.

9. The film according to claim 4, wherein the plurality of low-resistance layers are provided alternately on an outer side and an inner side of the heat generating layer in the longitudinal direction.

10. The film according to claim 1, wherein the conductive layers are provided on an outer side of the heat generating layer.

11. The film according to claim 1, wherein the conductive layers are formed of the same material as that of the low-resistance layer.

12. The film according to claim 4, wherein the intervals at which the plurality of low-resistance layers are provided vary between a central portion of the heat generating layer and each end of the heat generating layer in the longitudinal direction.

13-23. (canceled)

24. A fixing apparatus that fixes an image to a recording material, the fixing apparatus comprising:
a heating rotating member having a heat generating layer, and a first conductive layer and a second conductive layer provided respectively at one end and another end of the heating rotating member in a longitudinal direction of the heating rotating member so as to contact the heat generating layer, the first conductive layer and the second conductive layer both having a lower volume resistivity than that of the heat generating layer; and
power feeding members that contact the first conductive layer and the second conductive layer, respectively,
wherein the heat generating layer generates heat by a current flowing between the power feeding members of the heat generating layer, and the image is fixed to the recording material by heat from the heating rotating member, and
wherein the heating rotating member has a low-resistance layer formed in an area of the heat generating layer between the first conductive layer and the second conductive layer in the longitudinal direction so as not to contact the first conductive layer and the second conductive layer, the low-resistance layer having a lower volume resistivity than that of the heat generating layer and extending in a circumferential direction of the heat generating layer.

25. A fixing apparatus that fixes an image to a recording material, the fixing apparatus comprising:
a heating rotating member having a heat generating layer;
power feeding members that contact one end and another end of the heating rotating member in a longitudinal direction of the heating rotating member, the heat generating layer generating heat by a current flowing between the power feeding members of the heat generating layer; and
a pressurizing member that forms a nip portion in cooperation with the heating rotating member;
wherein, in the nip portion, the recording material on which the image is formed thereon is heated while being conveyed to fix the image to the recording material, and
wherein the heating rotating member has a plurality of low-resistance layers formed in a conveying area for the recording material in the heat generating layer at intervals in the longitudinal direction so as not to contact one another, each of the low-resistance layers having a lower volume resistivity than that of the heat generating layer, and extending in a circumferential direction of the heat generating layer.

26. The fixing apparatus according to claim 24, wherein the low-resistance layer is an annular layer.

27. The fixing apparatus according to claim 24, wherein the conductive layers are annular layers extending in the circumferential direction of the heat generating layer.

28. The fixing apparatus according to claim 24, wherein a plurality of the low-resistance layers is provided at intervals.

29. The fixing apparatus according to claim 28, wherein an interval between the adjacent low-resistance layers is 0.2 mm or more to a value equal to or less than a circumferential length of the heat generating layer.

30. The fixing apparatus according to claim 24, wherein a volume resistivity of the low-resistance layer with respect to the volume resistivity of the heat generating layer is between 1 to 1000 and 1 to 100.

31. The fixing apparatus according to claim 24, wherein a thickness of the low-resistance layer is 5 μm or more to 100 μm or less.
